(19) United States
(12) Patent Application Publication
(10) Pub. No.: US 2024/0191035 A1
(43) Pub. Date: Jun. 13, 2024

(54) RING OPENING POLYMERIZATION OF CYCLIC SILOXANES

(71) Applicant: CHT USA Inc, Cassopolis, MI (US)

(72) Inventors: Brian Patrick Mulhern, Edwardsburg, MI (US); Robert William Graff, Niles, MI (US)

(21) Appl. No.: 18/519,796

(22) Filed: Nov. 27, 2023

Related U.S. Application Data
(60) Provisional application No. 63/385,127, filed on Nov. 28, 2022.

(51) Int. Cl. C08G 77/08; B01J 31/02

(52) U.S. Cl. CPC C08G 77/08; B01J 31/0227

(57) ABSTRACT

The invention describes methods to produce high molecular weight silicones via ring opening polymerization of cyclic siloxanes in the presence of a Lewis acid catalyst.

### CROSS REFERENCE TO RELATED APPLICATIONS

This application claims the benefit of provisional application Ser. No. 63/385,127, filed Nov. 28, 2022, the entire content of which is incorporated herein by reference.

### FIELD OF THE INVENTION

The invention relates generally to methods to produce high molecular weight silicones via ring opening polymerization of cyclic siloxanes in the presence of a Lewis acid catalyst.

### BACKGROUND OF THE INVENTION

High molecular weight polysiloxane with viscosities that can exceed 20 million centipoise (cP), also known as silicone gums, find use in several applications including, for example, additives for slip and anti-mar additives in coatings, such as leather finishes and coatings and band ply lubricants used in the manufacture of tires.

These high molecular weight silicone polymers required extensive facilities and capital investment to produce the silicon polymers at production scale. These issues present difficulties for smaller operators to produce such silicone polymers.

Production of these high molecular weight polysiloxanes are often accomplished via a condensation reaction between lower molecular weight siloxanes. However, during such processes, insoluble small molecules are produced, such as for example but not limited to, water, methanol, ethanol, propanol, butanol, and acetic acid. This results in poor high molecular weight siloxane purity as insoluble byproducts are considered impurities. In order to achieve a visually clear, and pure product, the insoluble impurities must be removed which results in increased costs of the desired product.

High molecular weight polysiloxanes are typically produced using strong protic acids or bases.

High molecular weight siloxanes are typically produced through a condensation or ring opening polymerization with limited control over chain end-functionality. Typical homofunctional polymers include hydroxyl, trimethyl silyl, hydride and vinyl as chain end groups. The ability to prepare heterotelechelic siloxane polymers is currently limited to anionic ring opening polymerization. This methodology is limited since it requires stringent processes and preparation, raw materials that are more expensive and the use of strong organic lithium compounds that are often hazardous.

Therefore, a need exists that overcomes one or more of the current disadvantages noted above.

### BRIEF SUMMARY OF THE INVENTION

The present embodiments surprisingly provide an efficient straightforward method to polymerize one or more cyclic siloxane(s). The one or more cyclic siloxane(s) is/are combined with a Lewis acid catalyst at a temperature of from about 20° C. to about 400° C. to form a reaction mixture. The one or more cyclic siloxane(s) have a formula

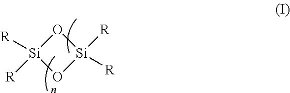

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide.

In one embodiment, the product obtained from the reaction mixture has a formula (II) [(HO)R₂SiO_{1/2}]₂(R₂SiO_{2/2})ₘ, where m>n, a high molecular weight polysiloxane.

In another embodiment, the product obtained from the reaction mixture has a formula (III) [(HO)R₂SiO_{1/2}](R₂SiO_{2/2})ₘ[SiO_{1/2}R₂(Z)], where m>n, a high molecular weight functionalized polysiloxane. Z can be for example, a nucleophilic group, such as an amine, an alkoxy group, a trialkylsiloxy group, an acetate, an alkyl ester, a silazanyl group, an aminosilyl group, an amino silicone group. Other suitable Z groups include, for example, water, cyanides, thiols, alcohols, protic bases (NaOH, KOH), amines, amides, amino silanes, halides, azides, phosphines, inorganic hydrides (NaH, LiAlH₄), n-butyl lithium and/or organic lithium reagents.

In another embodiment, the product obtained from the reaction mixture has a formula (IV) [(TO)R₂SiO_{1/2}](R₂SiO_{2/2})ₘ[SiO_{1/2}R₂(OH)], where m>n, a high molecular weight functionalized polysiloxane. T is an electrophilic functional group

In still another embodiment, the product obtained from the reaction mixture has a formula (V) [(TO)R₂SiO_{1/2}](R₂SiO_{2/2})ₘ[SiO_{1/2}R₂(Z)], where m>n, a high molecular weight functionalized polysiloxane, wherein Z and T are as described herein.

The present methods provide advantages over currently known processes and high molecular weight polysiloxanes including functionalized products. The methods provide high molecular weight polysiloxanes, including the functionalized products without significant capital investment by using standard process equipment such as a standard drum mixer and drum heater.

Suitable Lewis Acids include (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

One advantage of the present embodiments is that the use of pressure to drive the reaction is not required.

Another advantage of the present embodiments is that the reaction can occur at ambient temperature or at a temperature of less than about 60° C.

Still another advantage of some of the embodiments is that insoluble small molecules, such as water, short chain alcohols (methanol, ethanol, propanol, butanol) and/or acetic acid as potential by products, are not generated.

Yet another advantage of the current embodiments is that a solvent is not necessitated for the reaction process. A solvent is an option but is not required. Another advantage is that there is no requirement for a protic acid in combination with the preferred Lewis acid, bismuth triflate.

Another advantage is controlling molecular weight through equilibrium reaction conditions including terminal end groups like hexamethyldisiloxane. For example, instead of adding a cyclic polysiloxane and catalyst together and allowing the reaction to progress, another component is added that endcaps the polymer. This endcap effectively restricts the growth of the polymer and enables the tailoring of the molecular weight of the final polymer by adjusting the concentration of the endcap in the system. For example, example 15-32-1 (below) is a standard ROP and in 166.8 hours achieved a M_{w} of 612,172 g/mol while the equilibration experiment (15-33-1) was allowed to react at the same conditions for 604.6 hours and only reached a M_{w}66,465 g/mol. Endcapping reagents, include but are not limited to, hexamethyldisiloxane, hexamethyldisilazane, short chain PDMS, alkoxy silanes, alcohols, Grignard reagents, carboxylates, thiols, Amines, amides, water, inorganic hydrides (NaH, LiAlH₄), tetramethyldisiloxane, tetramethyldisilazane, tetramethyldivinyldisiloxane, tetramethyldivinyldisilazane, alkoxy silanes, amino silanes, glycidyl silanes, and or halosilanes and nucleophiles in general that can act as an endcapping agent.

Another advantage is the formation of asymmetric silicone alkoxides without the need of a halosilane starting material like a chlorosilane. These silicone alkoxides are made from the resulting polymer from the reaction of cyclic silicones and bismuth triflate. The silicone alkoxides can be made with controlled molecular weight and functionality.

Another advantage could be that the preferred catalyst (bismuth triflate) is significantly easier to handle and is less hazardous than published examples of alternative Lewis acids like SbCl₅ or tetrakis(pentafluorophenyl)-borate.

Still another advantage of the embodiments disclosed herein is the ability to synthesize the polysiloxanes, including the functionalized products, described herein without the extensive equipment required to manufacture gum, like a twin-screw extruder. Advantageously, the components can be combined, for example, in a 55 gallon drum, mixed for a day at ˜65° C., then placed in a hot room at ˜70° C. for a week until the reaction(s) is/are complete. This is also an added benefit for energy efficiency and “greener” chemistry that requires less effort, energy, and cost to achieve a similar product.

Yet another advantage is that the present methods/processes provide the ability to make asymmetric or symmetric terminal functionalization. This provides extended industrial significance as high molecular weight siloxanes are typically synthesized symmetrically with the option to further functionalize the terminal positions. Such processes results in increased cost to the product and also fails to provide the ability to be prepare asymmetrically terminal substituted products.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

In the specification and in the claims, the terms “including” and “comprising” are open-ended terms and should be interpreted to mean “including, but not limited to . . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Suitable cyclic siloxanes for polymerization described herein include hexamethylcyclotrisiloxane (D3), octamethylcyclotetrasiloxane (D4), decamethylcyclopentasiloxane (D5), dodecamethylcyclohexasiloxane (D6), tetradecamethylcycloheptasiloxane (D7) and hexadecamethylcyclooctasiloxane (D8) and mixtures thereof. In certain aspects, D4 and/or D5 are suitable cyclic siloxanes.

The present invention surprisingly provides an efficient straightforward method to polymerize one or more cyclic siloxane(s). The one or more cyclic siloxane(s) is/are combined with a Lewis acid catalyst at a temperature of from about 20° C. to about 400° C. to form a reaction mixture. The one or more cyclic siloxane(s) have a formula

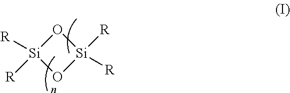

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide.

In one embodiment, the product obtained from the reaction mixture has a formula (II) [(HO)R₂SiO_{1/2}]₂(R₂SiO_{2/2})ₘ, where m>n, a high molecular weight polysiloxane.

The reaction temperature can range from about ambient conditions (approximately 25° C.) to about 400° C. but the process conditions are generally performed below 100° C. The reaction mixture can be heated from about 25° C. to about 100° C., or from about 25° C. to about 90° C., or from about 25° C. to about 80° C., from about 25° C. to about 70° C., from about 25° C. to about 60° C., from about 25° C. to about 50° C., from about 25° C. to about 40° C., or from about, from about 25° C. to about 30° C., and all temperatures and ranges included from about 25° C. to about 100° C., e.g., about 30° C. to about 100° C., about 31° C. to about 100° C., about 32° C. to about 100° C., etc. including from about 40° C. to about 100° C., about 50° C. to about 100° C., etc. with all temperatures and ranges included from about 30° C. to about 100° C.

In another embodiment, the product obtained from the reaction mixture has a formula (III) [(HO)R₂SiO_{1/2}](R₂SiO_{2/2})ₘ[SiO_{1/2}R₂(Z)], where m>n, a high molecular weight functionalized polysiloxane. Z can be for example, an amine, an alkoxy group, a trialkylsiloxy group, an acetate, an alkyl ester, a silazanyl group, an aminosilyl group, an amino silicone group.

In the context of the present specification, unless otherwise stated, an alkyl, alkenyl or alkynyl substituent group or an alkyl, alkenyl or alkynyl moiety in a substituent group may be linear or branched. Examples of C₁-C₆ alkyl groups/moieties include methyl, ethyl, propyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-pentyl, 3-methyl-1-pentyl, 4-methyl-1-pentyl, 2-methyl-2-pentyl, 3 -methyl-2-pentyl, 4-methyl-2-pentyl, 2,2-dimethyl-1-butyl, 3,3-dimethyl-1-butyl, 2-ethyl-1-butyl, n-butyl, isobutyl, tert-butyl, n-pentyl, isopentyl, neopentyl and n-hexyl. Examples of C₂-C₆ alkenyl groups/moieties include ethenyl, propenyl, 1-butenyl, 2-butenyl, 1-pentenyl, 1-hexenyl, 1,3-butadienyl, 1,3-pentadienyl, 1,4-pentadienyl and 1-hexadienyl. Examples of C₂-C₆ alkynyl groups/moieties include ethynyl, propynyl, 1-butynyl, 2-butynyl, 1-pentynyl and 1-hexynyl.

The branched or unbranched alkyl, alkenyl or alkynyl groups can be substituted with one or more substituents, such as halogens (Cl, I, Br), alkoxides, amino groups, thioalkoxides, hydroxyl groups, etc.

Aryl groups include aromatic monocyclic or multicyclic groups having in the range of 5 up to 19 carbon atoms. Suitable examples include, but are not limited to, phenyl, naphthyl, pyridyl, furanyl, imidazolyl, benimidazolyl, thienyl, quinolinyl, indolyl, thiazolyl, and the like.

Amino groups include those with the formula —NR₁R₂, wherein R₁ and R₂ are each independently an alkyl, alkenyl or alkynyl group which can be further substituted with substituents, such as those noted above.

Alkoxide groups include those with the formula —OR₁, wherein R₁ is as described above, an alkyl group, an alkenyl group, which can be further substituted with substituents, such as those, noted above.

In another embodiment, the product obtained from the reaction mixture has a formula (IV) [(TO)R₂SiO_{1/2}](R₂SiO_{2/2})ₘ[SiO_{1/2}R₂(OH)], where m>n, a high molecular weight functionalized polysiloxane. T is an electrophilic functional group, such as a hydrogen atom, acrylates, methacrylates, isocyanates, isothiocyanates, epoxides, alkylhalides, alpha-beta unsaturated alkenes, alkynes, nitriles, aldehydes, ketones, alkoxy silanes, glycidyl silanes, amino silanes, halosilanes, phosphines, boranes, haloboranes, sodium hydride, n-butyl lithium, organic lithium reagents, methyl methacrylate, methyl acrylate and/or butyl acrylate.

In still another embodiment, the product obtained from the reaction mixture has a formula (V) [(TO)R₂SiO_{1/2}](R₂SiO_{2/2})ₘ[SiO_{1/2}R₂(Z)], where m>n, a high molecular weight functionalized polysiloxane, wherein Z and T are as described herein.

It should be understood by those having ordinarily skill in the art that the reactions described herein provide the opportunity to functionalize the reactive intermediates with one or more end capping/functionalization reagents. Those listed herein are suitable for such end capping/functionalization but are not limited to those provided.

Lewis Acids are known in the art and at their fundamental nature are compounds or ionic species that can accept an electron pair from a donor compound, such as a Lewis Base. Lewis Acids include, for example, H⁺, K⁺, Mg²⁺, Fe³⁺, BF₃, CO₂, SO₃, RMgX, AlCl₃, Br₂. Lewis Bases include, for example, OH⁻, F⁻, H₂O, ROH, NH₃, SO₄²⁻, H⁻, CO, PR₃, and C₆H₆.

Lewis Acids also include (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

The concentration of the Lewis Acid in the reaction mixture should be from about 10 ppm to about 5000 ppm based on the weight of the cyclic siloxane(s). Suitable ranges include from about 50 ppm to about 4500 ppm, from about 100 ppm to about 3000 ppm, from about 200 ppm to about 2000 ppm, from about 300 ppm to about 1000 ppm, from about 400 ppm to about 500 ppm and all values and ranges from about 10 ppm to about 5000 ppm based on the weight of the cyclic siloxane(s). This includes values and ranges from about 11 ppm to about 4999 ppm, from about 12 ppm to about 4998 ppm, from about 13 ppm to about 4997 ppm, from about 14 ppm to about 4996 ppm and so forth including 10 ppm, 20 ppm, 30 ppm through 5000 ppm in 10 ppm increments including all ranges and subranges there between.

The reaction mixture can include a chelating ligand. In one embodiment the chelating ligand is a bisimine, such as 1,2-bis-(2-di-iso-propylphenyl) imino)ethane or 1,2-bis(2-di-tert-butylphenyl)imino)ethane which are commercially available. Other chelating ligands are known and can be found in U.S. Pat. No. 11,028,230, issued Jun. 8, 2021 to Belowich et al., the contents of which are incorporated herein by reference for all purposes.

The reaction can also include an optional solvent. However, a solvent is generally not required, which is an advantage of the current embodiments. If a solvent is utilized, it is an aprotic solvent such as tetrahydrofuran, toluene, dichloromethane, and/or polydimethylsiloxanes that are trimethylsiloxy terminated.

In one embodiment, the cyclic siloxane(s) and a Lewis acid catalyst can be combined at ambient temperature and left for the polymerization to occur. In other embodiments, the cyclic siloxane(s) and the Lewis acid catalyst are combined and heated, generally to about 60° C., until the polymerization is complete and remaining cyclic siloxane(s) are either not detected or are at acceptable levels (less than 2% by weight) as determined by suitable methods known in the art such as by gas chromatography of by measurement of non-volatile content (NVC).

One advantage of the present embodiments is that the use of pressure to drive the reaction is not required.

The polysiloxanes, including the functionalized products, produced by the present embodiments have a viscosity of from about 2,000 cP to about 200 million cP. Suitable ranges include from about 2500 cP to about 190 million cP, from about 3,000 cP to about 180 million cP, from about 4,000 cP to about 170 million cP, from about 5,000 cP to about 160 million cP, from about 6,000 cP to about 150 million cP and all values and ranges from about 2,000 cP to about 200 million cP for the polysiloxane. This includes values and ranges from about 2,100 cP to about 199 million cP, from about 2200 cP to about 198 million cP, from about 2300 cP to about 197 million cP, from about 2400 cP to about 196 million cP and so forth.

For polysiloxanes, including the functionalized products, with a viscosity under 500,000 cP, a Brookfield DV2T viscometer was utilized with an LV spindle 3 or 4 from 30 rpm to 0.2 rpm at 25° C. For polysiloxanes, including the functionalized products, with a viscosity over 500,000 cP, a Waters/TA instruments HR-3 rheometer was used with variable shear rate, e.g., 0.01-1/s shear at 25° C.

M_{w} for the polymers (II), (III), (IV) and/or (V) described herein can range from about 25,000 g/mol through about 1,000,000 g/mol. Suitable ranges include from about 30,000 g/mol to about 900,000 g/mol, from about 40,000 g/mol to about 750,000 g/mol, from about 100,000 g/mol to about 500,000 g/mol, from about 300,000 g/mol to about 700,000 g/mol, from about 400,000 to about 500,000 g/mol and all values and ranges from about 25,000 g/mol to about 1,000,000 g/mol. This includes values and ranges from about 25,001 to about 999,999 g/mol, from about 25,002 g/mol to about 999,998 g/mol, from about 25,0003 g/mol to about 999,997 g/mol, from about 25,004 g/mol to about 999,996 g/mol and so forth including 25,010 g/mol, 25,020 g/mol, 25,030 g/mol through 1,000,000 g/mol in 10 g/mol increments including all ranges and subranges there between.

Mₙ for the polymers (II), (III), (IV) and/or (V) described herein can range from about 15,000 g/mol through about 600,000 g/mol. Suitable ranges include from about 30,000 g/mol to about 500,000 g/mol, from about 50,000 g/mol to about 450,000 g/mol, from about 100,000 g/mol to about 500,000 g/mol, from about 200,000 g/mol to about 400,000 g/mol, from about 300,000 to about 400,000 g/mol and all values and ranges from about 15,000 g/mol to about 600,000 g/mol. This includes values and ranges from about 15,001 to about 599,999 g/mol, from about 15,002 g/mol to about 599,998 g/mol, from about 15,0003 g/mol to about 959,997 g/mol, from about 15,004 g/mol to about 599,996 g/mol and so forth including 15,010 g/mol, 15,020 g/mol, 15,030 g/mol through 600,000 g/mol in 10 g/mol increments including all ranges and subranges there between.

D, polydispersity, for the polymers (II), (III), (IV) and or (V) described herein can range from 1 to 2.5 and all values there between including including 0.01 increments up to 2.5 including all ranges and subranges there between, e.g., 1.01, 1.02, 1.03, 1.04, etc. at 0.1 increments through about 2.5.

Further the siloxane polymers can be cross-linked to form cured rubbers that can be transparent. The siloxane polymer ((II), (III), (IV), (V) alone or in combination(s)) can be treated with a suitable cross linker at ambient or elevated temperatures as described herein. The cross linker can include 2 or 3 or more reactive groups per molecule that can combine with reactive groups. Suitable crosslinking agent include for example, but are not limited to tetraethyl ortho s ilic ate, methyltrimethoxysilane, alkoxy silanes such as methyltrimethoxysilane, tetraethylortho s ilic ate, methyltriethoxysilane, ethyltrimethoxysilane, aminoethylaminopropyltrimethoxysilane, n-octyltriethoxysilane, methacryloxypropyltrimethoxysilane, acryloxypropyltriethoxysilane, vinyltrimethoxysilane, vinyltriethoxysilane, trimethoxysilane, triethoxysilane, alcohols such as glycerin, trimethylolpropane), carboxylates such as ethylenediaminetetraacetic acid, citric acid, aconitic acid, propane-1,2,3-tricarboxylic acid, agaric acid, trimesic acid, amines such as diethylenetriamine, benzene-1,3,5-triamine, triethylenetetramine, thiols such as pentaerythritol tetrakis (3-mercaptopropionate), propane trithiol, ethane-1,2-tetrathiol, azides such as boron triazide, tetraazidomethane, silicon tetraazaide, amides, alkyl esters such as triacylglycerol, phosphines, pentaerythritol, glycerol, sugar alcohols, polymeric polyols and/or Grignard reagents and those known the art.

The following paragraphs enumerated consecutively from 1 through 91 provide for various aspects of the present invention. In one embodiment, in a first paragraph (1), the present invention provides 1. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula

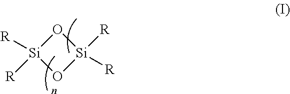

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide; and
obtaining a product from the mixture, wherein the product comprises formula (II) [(HO)R₂SiO_{1/2}]₂(R₂SiO_{2/2})ₘ, where m>n.
2. The method according to paragraph 1, wherein n is from 2 to 10.
3. The method according to paragraph 2, wherein n is from 3 to 8.
4. The method according to paragraph 3, wherein n is from 4 to 8.
5. The method according to any of paragraphs 1 through 4, wherein the product has a viscosity of from 2,000 cP to about 200 million cP.
6. The method according to paragraph 5, wherein the product viscosity is from about 2500 cP to about 100 million cP.
7. The method according to any of paragraphs 1 through 6, wherein each R is a methyl or ethyl group.
8. The method according to any of paragraphs 1 through 6, wherein each R, independently, is one of a methyl group, an ethyl group or a phenyl group.
9. The method according to any of paragraphs 1 through 8, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.
10. The method according to paragraph 9, wherein the Lewis acid catalyst is bismuth (III) triflate.
11. The method according to any of paragraphs 1 through 10, wherein the Lewis acid catalyst is present in an amount of 10 ppm to 5000 ppm based on the weight of the cyclic siloxane.
12. The method according to any of paragraphs 1 through 11, further comprising a solvent.
13. The method according to paragraph 12, wherein the solvent is water.
14. The method according to any of paragraphs 1 through 13, wherein the reaction temperature is from about 40° C. to about 100° C.
15. The method according to paragraph 14, wherein the reaction temperature is from about 60° C. to about 70° C.
16. The method according to any of paragraphs 1 through 15, further comprising a chelating ligand.
17. The method according to paragraph 16, wherein the chelating ligand is a bisimine.
18. The method according to any of paragraphs 1 through 17, wherein the chelating ligand is combined with the Lewis acid catalyst prior to combing the Lewis acid with the cyclic siloxane.
19. The method according to any of paragraphs 1 through 17, wherein the chelating ligand is combined with the reaction mixture after the Lewis acid catalyst and cyclic siloxane were combined.
20. The method according to any of paragraphs 1 through 19, wherein the chelating ligand is present in an amount of 10 ppm to 1000 ppm based on the weight of the cyclic siloxane.
21. The method according to any of paragraphs 1 through 20, wherein the reaction mixture is stirred.
22. The method according to any of paragraphs 1 through 21, further comprising a quenching the reaction mixture with a quenching agent.
23. The method according to paragraph 22, wherein the quenching agent is an amine or water.
24. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula

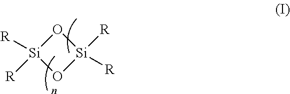

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with a nucleophilic agent, Z; and
obtaining a product from the mixture, wherein the product comprises formula (III) [(HO)R₂SiO_{1/2}](R₂SiO_{2/2})ₘ[SiO_{1/2}R₂(Z)], wherein m>n and Z comprises an amine, an alkoxy group, a trialkylsiloxy group, an acetate, an alkyl ester, a silazanyl group, an aminosilyl group, or an amino silicone group.
25. The method according to paragraph 24, wherein n is from 2 to 10.
26. The method according to paragraph 25, wherein n is from 3 to 8.
27. The method according to paragraph 26, wherein n is from 4 to 8.
28. The method according to any of paragraphs 24 through 27, wherein the product has a viscosity of from 2,000 cP to about 200 million cP.
29. The method according to paragraph 28, wherein the product viscosity is from about 2500 cP to about 100 million cP.
30. The method according to any of paragraphs 24 through 29, wherein each R is a methyl or ethyl group.
31. The method according to any of paragraphs 24 through 39, wherein each R, independently, is one of a methyl group, an ethyl group or a phenyl group.
32. The method according to any of paragraphs 24 through 31, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.
33. The method according to paragraph 32, wherein the Lewis acid catalyst is bismuth (III) triflate.
34. The method according to any of paragraphs 24 through 33, wherein the Lewis acid catalyst is present in an amount of 10 ppm to 5000 ppm based on the weight of the cyclic siloxane.
35. The method according to any of paragraphs 24 through 34, further comprising a solvent.
36. The method according to paragraph 35, wherein the solvent is water.
37. The method according to any of paragraphs 24 through 36, wherein the reaction temperature is from about 40° C. to about 100° C.
38. The method according to paragraph 37, wherein the reaction temperature is from about 60° C. to about 70° C.
39. The method according to any of paragraphs 24 through 38, further comprising a chelating ligand.
40. The method according to paragraph 39, wherein the chelating ligand is a bisimine.
41. The method according to any of paragraphs 24 through 40, wherein the chelating ligand is combined with the Lewis acid catalyst prior to combing the Lewis acid with the cyclic siloxane.
42. The method according to any of paragraphs 24 through 40, wherein the chelating ligand is combined with the reaction mixture after the Lewis acid catalyst and cyclic siloxane were combined.
43. The method according to any of paragraphs 24 through 42, wherein the chelating ligand is present in an amount of 10 ppm to 1000 ppm based on the weight of the cyclic siloxane.
44. The method according to any of paragraphs 24 through 43, wherein the reaction mixture is stirred.
45. The method according to any of paragraphs 24 through 44, further comprising a quenching the reaction mixture with a quenching agent.
46. The method according to paragraph 45, wherein the quenching agent is an amine.
47. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula

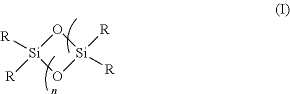

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with an electrophilic agent, T; and
obtaining a product from the mixture, wherein the product comprises formula (IV) [(TO)R₂SiO_{1/2}](R₂SiO_{2/2})ₘ[SiO_{1/2}R₂(OH)], wherein m>n and T comprises an electrophile.
48. The method according to paragraph 47, wherein n is from 2 to 10.
49. The method according to paragraph 48, wherein n is from 3 to 8.
50. The method according to paragraph 49, wherein n is from 4 to 8.
51. The method according to any of paragraphs 47 through 50, wherein the product has a viscosity of from 2,000 cP to about 200 million cP.
52. The method according to paragraph 51, wherein the product viscosity is from about 2500 cP to about 100 million cP.
53. The method according to any of paragraphs 47 through 52, wherein each R is a methyl or ethyl group.
54. The method according to any of paragraphs 47 through 52, wherein each R, independently, is one of a methyl group, an ethyl group or a phenyl group.
55. The method according to any of paragraphs 47 through 54, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.
56. The method according to paragraph 55, wherein the Lewis acid catalyst is bismuth (III) triflate.
57. The method according to any of paragraphs 47 through 56, wherein the Lewis acid catalyst is present in an amount of 10 ppm to 5000 ppm based on the weight of the cyclic siloxane.
58. The method according to any of paragraphs 47 through 57, further comprising a solvent.
59. The method according to paragraph 58, wherein the solvent is water.
60. The method according to any of paragraphs 47 through 59, wherein the reaction temperature is from about 40° C. to about 100° C.
61. The method according to paragraph 60, wherein the reaction temperature is from about 60° C. to about 70° C.
62. The method according to any of paragraphs 47 through 61, further comprising a chelating ligand.
63. The method according to paragraph 62, wherein the chelating ligand is a bisimine.
64. The method according to any of paragraphs 47 through 63, wherein the chelating ligand is combined with the Lewis acid catalyst prior to combing the Lewis acid with the cyclic siloxane.
65. The method according to any of paragraphs 47 through 63, wherein the chelating ligand is combined with the reaction mixture after the Lewis acid catalyst and cyclic siloxane were combined.
66. The method according to any of paragraphs 47 through 65, wherein the chelating ligand is present in an amount of 10 ppm to 1000 ppm based on the weight of the cyclic siloxane.
67. The method according to any of paragraphs 47 through 66, wherein the reaction mixture is stirred.
68. The method according to any of paragraphs 47 through 67, further comprising a quenching the reaction mixture with a quenching agent.
69. The method according to paragraph 68, wherein the quenching agent is an amine or water.
70. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula

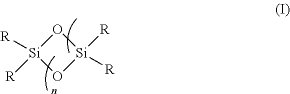

wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with an electrophilic agent, T and a nucleophilic agent, Z; and
obtaining a product from the mixture, wherein the product comprises formula (V) [(TO)R₂SiO_{1/2]}(R₂SiO_{2/2})ₘ[SiO_{1/2}R₂(Z)],
wherein m>n, Z comprises an amine, an alkoxy group, a trialkylsiloxy group, an acetate, an alkyl ester, a silazanyl group, an aminosilyl group, or an amino silicone group and T comprises an electrophile.
71. The method according to paragraph 70, wherein n is from 2 to 10.
72. The method according to paragraph 71, wherein n is from 3 to 8.
73. The method according to paragraph 72, wherein n is from 4 to 8
74. The method according to any of paragraphs 70 through 73, wherein the product has a viscosity of from 2,000 cP to about 200 million cP.
75. The method according to paragraph 74, wherein the product viscosity is from about 2500 cP to about 100 million cP.
76. The method according to any of paragraphs 70 through 75, wherein each R is a methyl or ethyl group.
77. The method according to any of paragraphs 70 through 75, wherein each R, independently, is one of a methyl group, an ethyl group or a phenyl group.
78. The method according to any of paragraphs 70 through 77, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.
79. The method according to paragraph 70, wherein the Lewis acid catalyst is bismuth (III) triflate.
80. The method according to any of paragraphs 70 through 79, wherein the Lewis acid catalyst is present in an amount of 10 ppm to 5000 ppm based on the weight of the cyclic siloxane.
81. The method according to any of paragraphs 70 through 80, further comprising a solvent.
82. The method according to paragraph 81, wherein the solvent is water.
83. The method according to any of paragraphs 70 through 82, wherein the reaction temperature is from about 40° C. to about 100° C.
84. The method according to paragraph 83, wherein the reaction temperature is from about 60° C. to about 70° C.
85. The method according to any of paragraphs 70 through 84, further comprising a chelating ligand.
86. The method according to paragraph 85, wherein the chelating ligand is a bisimine.
87. The method according to any of paragraphs 70 through 86, wherein the chelating ligand is combined with the Lewis acid catalyst prior to combing the Lewis acid with the cyclic siloxane.
88. The method according to any of paragraphs 70 through 86, wherein the chelating ligand is combined with the reaction mixture after the Lewis acid catalyst and cyclic siloxane were combined.
89. The method according to any of paragraphs 70 through 88, wherein the chelating ligand is present in an amount of 10 ppm to 1000 ppm based on the weight of the cyclic siloxane.
90. The method according to any of paragraphs 70 through 89, wherein the reaction mixture is stirred.
91. The method according to any of paragraphs 1 through 90, further comprising the step of adding a crosslinking agent to the polysiloxane product.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### Examples

### Procedure for Non-Volatile Component (NVC) Percentage

A DSC brand HFT 2000M Moisture Analyzer (now 4000M) moisture balance was utilized. Into an aluminum pan is placed a substrate pad and tared to zero. A 0.5 to 1.0 gram sample is added onto the substrate and the system is closed so that the sample is heated to a set point (130° C.) in the closed chamber. The temperature is held until the mass of the sample no longer changes and the mass delta is calculated as the NVC.

An alternative method used to determine residual D4-D10 components was by gas chromatography (GC). A Shimadzu Nexis GC-2030 with a column of RESTEK 30 m×0.25 mm ID with a 0.1 micrometer film thickness wax column was utilized. Samples were prepared by taking approximately 100 mg of sample which was diluted with 10 mL of hexanes. 1 mL of the solution was added to a GC vial to which is added approximately 200 microliters of hexamethyl disilazane (HMDZ) to quench the reaction. A sample of the quenched reaction mixture is injected into the GC with a GC profile of 40° C. ramping at 25° C./minute with a hold at 350° C. for 30 minutes for a total run time of 41 minutes and a column flow rate of 0.7 mL/minute, split ratio of 25:10 and compared to standardized D4-D10 samples to obtain percentage concentrations of the residual cyclic(s) content. The GC methodology provided more accurate measurements of the NVC's.

All reported molecular weights were calculated using PDMS standards (311 Da to 305000 Da in toluene). The instrument used was a Shimadzu LC-2050C 3D liquid chromatograph with Shimadzu RID-20A RID detector, with toluene as eluent, GPC column was Shodex KF-805L 300×8 mm pre column 5000 Å+Shodex KF-803L 300×8 mm 500 Å, 5 μm, polystyrene-divinylbenzene, run at 40° C., 1 mL/min, injection of 100 μL. Sample preparation was 100 mg of sample into a premixed solution of 10 g toluene and 0.2 g of hexamethyldisilazane, aliquot was added to 1.5 mL HPLC vial. Software utilized to determine M_{w}, Mₙ and D was by Shimadzu and is called LabSolutions LC/GC and has a release version of 5.92.

### EXP-15-26-1, Standard D4 ROP (Ring Opening Polymerization) With 250 ppm Bi(TfO)₃ Catalyst

A 250 mL 3-neck round bottom flask equipped with a magnetic stir bar, reflux condenser, and septa was charged with 0.0243 g of Bi(TfO)₃ and 99.9857 g of octamethylcyclotetrasiloxane. The reaction was stirred and heated to 120° C. using a thermocouple hot plate and a silicone oil bath for 332.9 hours. The reaction yielded a final polymer with a Mn of 250941 g/mol, Mw of 538689 g/mol, and D of 2.15.

### EXP-15-29-1, Standard D5 ROP With 250 ppm Bi(TfO)₃ Catalyst

A 250 mL 3-neck round bottom flask equipped with a magnetic stir bar, reflux condenser, and septa was charged with 0.0273 g of Bi(TfO)₃ and 100.88 g of decamethylcyclopentasiloxane. The reaction was stirred and heated to 120° C. using a thermocouple hot plate and a silicone oil bath for 238 hours. The reaction yielded a final polymer with a Mn of 310433 g/mol, Mw of 634715 g/mol, and D of 2.04.

### EXP-15-29-2, Standard D6 ROP With 250 ppm Bi(TfO)₃ Catalyst

A 250 mL 3-neck round bottom flask equipped with a magnetic stir bar, reflux condenser, and septa was charged with 0.0262 g of Bi(TfO)₃ and 99.9750 g of dodecamethylcyclohexasiloxane. The reaction was stirred and heated to 120° C. using a thermocouple hot plate and a silicone oil bath for 238 hours. The reaction yielded a final polymer with a Mn of 164987 g/mol, Mw of 289805 g/mol, and D of 1.76.

### EXP-15-33-1, Equilibrium Reaction, 250 ppm Bi(TfO)₃ Catalyst D5 ROP

A 250 mL 3-neck round bottom flask equipped with a magnetic stir bar, reflux condenser, and septa was charged with 99.52 g of decamethylcyclopentasiloxane, 0.48 g of hexamethyldisiloxane, and 0.0373 g of Bi(TfO)₃. The reaction was stirred and heated to 80° C. using a thermocouple hot plate and a silicone oil bath for 304.6 hours. The reaction yielded a final polymer with Mn of 36733 g/mol, Mw of 66465 g/mol, and D of 1.81. The hexamethyldisiloxane (HMDS) acts as an end cap. Based on the concentration of the HMDS, the molecular weight of the final polymer can be controlled. It is an equilibration type polymerization where everything is added to the pot and reacted and it equilibrates to the molecular weight possible based on the amount of endcap in the system.

### EXP-15-35-1, D5 ROP W/250 ppm Bi(TfO)₃ Catalyst and 500 ppm H₂O

A 250 mL 3-neck round bottom flask equipped with a magnetic stir bar, reflux condenser, and septa was charged with 100.32 g of decamethylcyclopentasiloxane, 50 μL of H₂O, and 0.0247 g of Bi(TfO)₃. The reaction was stirred and heated to 120° C. using a thermocouple hot plate and a silicone oil bath for 91.7 hours. The reaction yielded a final polymer with Mn of 116244 g/mol, Mw of 182659 g/mol, and D of 1.57.

### EXP-15-32-1, Standard D5 ROP With 250 ppm Bi(TfO)₃ Catalyst, Finished Reaction in an Oven

A 1200 mL beaker equipped with an overhead mixer with agitator and thermocouple hotplate was charged with 749.62 g of decamethylcyclopentasiloxane and 0.1870 g of Bi(TfO)₃ catalyst. The reaction was elevated to 80° C. and was mixed using the overhead stifling unit. The reaction was covered with aluminum foil to prevent evaporation. The polymerization was allowed to continue until the reaction viscosity exceeded the ability of the overhead mixer to sufficiently mix the reaction, which occurred at hour 29.5 of the reaction. The remaining reaction occurred within a 65° C. oven with the beaker fully covered with aluminum foil. The polymerization was carried out over a total of 166.8 hours to yield a final polymer with an Mn of 359647 g/mol, Mw of 612172 g/mol, and D of 1.70.

### EXP-15-42-1, Dispersing EXP-15-32-1 in D5 Without Quenching

A 600 mL beaker equipped with an overhead mixer with agitator was charged with 339.24 g decamethylcyclopentasiloxane and 59.85 g of EXP-15-32-1. The mixture was allowed to mix until the polymer from EXP-15-32-1 was fully dissolved. This polymer dispersion was allowed to stand at ambient conditions for 16 hours. The resulting dispersion demonstrated the EXP-15-32-1 polymer had changed to a Mn of 139570 g/mol, Mw of 226637 g/mol, and D of 1.62.

### EXP-15-42-2, Dispersing EXP-15-32-1 in D5 With Quenching

A 600 mL beaker equipped with an overhead mixer with agitator was charged with 341.15 g decamethylcyclopentasiloxane, 40 μL of 15% aqueous sodium hydroxide, and 59.88 g of EXP-15-32-1. The mixture was mixed until the polymer from EXP-15-32-1 was fully dissolved. This polymer dispersion was allowed to stand at ambient conditions for 16 hours. The resulting dispersion demonstrated the EXP-15-32-1 polymer had changed to a Mn of 395223 g/mol, Mw of 753226 g/mol, and D of 1.91.

### EXP-9-4-1, Demonstrating Low Catalyst Load

A 150 mL beaker equipped with a magnetic stir bar was charged with 100 g of D5 and 5 mg of Bi(TfO)₃ (50 ppm). The beaker was sealed with aluminum foil and was heated with in-situ thermocouple control to maintain a temperature of 70° C. After 12 days at 70° C. the NVC of the solution was 0.45%, demonstrating an extremely slow rate of reaction. NVC was determined by the procedure as described above.

### EXP-9-5-1, Demonstrating Reaction Results at Low Temperature

A 150 mL beaker equipped with a magnetic stir bar was charged with 100 g of D5 and 25 mg of Bi(TfO)₃ (250 ppm). The beaker was sealed with aluminum foil and allowed to stir at room temperature for 12 days. The final NVC of this system was 0.00%, demonstrating a negligibly progressing reaction. NVC was determined by the procedure as described above.

### EXP-8-100-1, Catalyzed Ring Opening Polymerization of D5 With KOH

A 250 mL beaker equipped with a magnetic stir bar was charged with 150 g of D5 and 0.05 g of KOH solid. The beaker was sealed with aluminum foil and heated with stirring to maintain a temperature of 80° C. After 13 days at 80° C., the NVC of the solution was 3.79%. NVC was determined by the procedure as described above.

### EXP-8-89-1, Triflic Acid Co-Catalyst

A 600 mL beaker equipped with a magnetic stirrer was charged with 450 g of D5, 65.2 mg of Bi(TfO)₃, and 0.1 mL of Triflic acid. The beaker was sealed with aluminum foil and heated with thermocouple control to maintain internal temperature of 75° C. After two days, the NVC was 32.72%, the reaction system required mechanical agitation. The following day the reaction was transferred to an oven at 65° C. due to the viscosity being so great that the fluid could not be stirred. After 7 days from the start of the reaction, the polymer had a NVC of 98.26%. NVC was determined by the procedure as described above.

### EXP-9-10-1, Crosslinking EXP-8-81-2 With Tetraethyl Orthosilicate (TEOS)

A 200 mL speedmixer cup was charged with 50 g of EXP-8-81-2 polymer. The polymer was premixed for 30 seconds at 2300 rpm, and then the speedmixer cup with gum was charged with 0.1 g of TEOS, and speed mixed for 1.5 minutes at 2300 in 30 second intervals. The resulting viscous flowing liquid cures with moisture and evaporation of ethanol to form an elastomeric rubber.

This example is very similar to the reversible molecular weight modification noted herein, but instead of a monofunctional alcohol, an alkoxy silane is used to tie multiple polymers together making a room temperature cured, e.g., a cross-linked rubber that is transparent.

### EXP-15-36-5, 15-32-1 Gum W/Methyltrimethoxysilane, Crosslinking Modification

An 8 oz. speedmixer cup was charged with 26.44 g of 15-32-1 polymer and 1.12 g methyltrimethoxysilane. This mixture was speedmixed at 2300 RPM in 30 second intervals until the alcohol was consumed by the reaction. The resulting polymer demonstrated the EXP-15-32-1 polymer had changed to a Mn of 13077 g/mol, Mw of 86363 g/mol, and D of 6.60. Approximately 2 g of the resulting methyltrimethoxysilane modified polymer was allowed to sit exposed to ambient conditions and air for 16 hours. The polymer had crosslinked to a clear elastomer and was subsequently insoluble in toluene.

### EXP-15-36-8, 15-32-1 Gum W/4% Methanol, Reversible MW Modification

An 8 oz. speedmixer cup was charged with 25.33 g of 15-32-1 polymer and 1.05 g methanol. This mixture was speedmixed at 2300 RPM in 30 second intervals until the alcohol was consumed by the reaction. The resulting polymer demonstrated the EXP-15-32-1 polymer had changed to a Mn of 38856 g/mol, Mw of 72582 g/mol, and D of 1.87. Approximately 2 g of the resulting methanol modified polymer was allowed to sit exposed to ambient conditions and air for 16 hours. The polymer was again analyzed by GPC and demonstrated the polymer had reverted to its initial high molecular weight by changing to Mn of 335430 g/mol, Mw of 670115 g/mol, and D of 2.00.

The above example demonstrates the ability to not only react a polymer product directly with alcohols, but that it rapidly causes the polymer to decrease in molecular weight and viscosity. What is interesting is that if the resulting alcohol functionalized polymer (which is a free flowing liquid) open to atmosphere for several hours, it reverts to a high molecular weight. Not to be limited by theory, it is possible that alcohols are inserting into the backbone of the silicone and the Si—O—C bonds are hydrolytically sensitive and with enough humidity alcohol loss can ensue and revert to the original polymer product.

### EXP-9-7-2, Dispersing Polymer From EXP8-81-2 in D5 With a Quenching Agent

KOH was utilized because better clarity of the mixture was achieved versus NaOH.

A 600 mL beaker equipped with a mechanical overhead stirrer and 4 blade prop agitator was charged with 340 g of D5, 60 g of polymer produced in EXP-8-81-2, and 40 μL of a 50% KOH aqueous solution. After 24 hrs, this experiment yielded a product with a viscosity of 2610 cP and a NVC of 12.35%.

Mₙ was calculated from GPC raw data fit to PDMS standard calibrations.

M_{w} was calculated from GPC raw data fit to PDM standard calibrations.

D is polydispersity index calculated by PDI=M_{w}/Mₙ using M_{w} and Mₙ from GPC data.

### EXP 8-81-2

A 5 gallon stainless steel vessel equipped with an overhead agitator and thermocouple hot plate was charged with 16.32 kg of D5 and 2.5 g of Bi(TfO)₃ (150 ppm). After 9 days, the NVC was 30.08%. The reaction mixture was then transferred to a polyethylene 5 gallon pail and was sealed with a lid. The pail was then placed in a 160° F. hot room. After a 5 days at elevated temperature, NVC was 82.67%, after 6 days the NVC was 86.49%, after 8 days the NVC was 96.64%, and after 10 days, the NVC was 97.5%. The reaction product was analyzed using GC (method described above) to achieve D4 wt % of 4.81%, D5 wt % of 4.36%, and D6 wt % of 1.19%.

### EXP 9-15-1

An open head 55 gallon steel drum equipped with an electric heating blanket and drum mixer was charged with 139.25 kg D5. The D5 was heated with stirring with the blanket set temperature of 225° F. After a few hours, 34.81 g of Bi(TfO)₃ was added to the reaction. The reaction temperature was measured as 125° F. Heating was discontinued overnight but reaction mixture was stirred continuously. The next morning the reaction mixture's temperature was 133° F. and the reaction mixture had a NVC of 17.04%. Within an additional six hours, the NVC was 41.91% and the reaction mixture had a viscosity of 185,500 cP as measured on Brookfield DVNext cone and plate viscometer using cone CP-52, at 3RPM, at 25° C. The reaction drum was sealed and placed in a 160° F. hot room on thereafter. After 3 days of heating, the NVC was 98.10%, and after 4 days of heating, the NVC was 98.46%. GC analysis using previous discussed methods yielded D4 wt % of 4.99%, D5 wt % of 3.68%, and D6 wt % of 1.24%.

### EXP 8-92-1

A 600 mL glass beaker equipped with an overhead agitator was charged with 72 g of EXP 8-81-2 product and 328 g of isododecane. This mixture was mixed until homogenous. Final viscosity was 60 cP and the final NVC was 14.04%. GC analysis using methods previously described yielded a D4 wt % of 0.47%, D5 wt % of 0.02%, and D6 wt % of 0.24%. The final viscosity was measured via DV2T and found to be 60 cP.

### EXP 8-92-2

A 600 mL glass beaker equipped with an overhead agitator was charged with 72 g of EXP 8-81-2 product 328 g of isododecane, and 0.2 g hexamethyldisilazane. This mixture was mixed until homogenous. Final viscosity was 1750 cP and the final NVC was 14.37%. GC analysis using methods previously described yielded a D4 wt % of 0.82%, D5 wt % of 0.03%, and D6 wt % of 0.22%. The final viscosity was found to be 1750 cP via DV2T.

### EXP 9-16-2

A 600 mL glass beaker equipped with an overhead agitator was charged with 340 g of D5, 60 g of EXP 9-15-1 product, and 40uL of 15% NaOH water solution. The mixture was mixed until homogenous and yielded a fluid of viscosity 9750 cP, and NVC of 11.84%. GC analysis yielded D4 wt % of 0.79%, and a D6 wt % of 2.0%. The mixture was allowed to age for 14 days. The reaction product was monitored for variations in NVC and viscosity. NVC was tested using moisture balance and the viscosity was measured by using Brookfield DV2T viscometer, spindle LV-3 at 6 rpm at 25 C for a value of 9750 cP. During the testing period, the sample was kept sealed in a 50° C. oven for accelerated aging.

| Day | Viscosity (cP) | NVC % |
|---|---|---|
| 1 | 9750 | 11.84 |
| 6 | 10300 | 12.01 |
| 8 | 10620 | 12.93 |
| 14 | 10240 | 12.15 |

### EXP-15-37-3, 15-32-1 Gum W/1% Ethanol

An 8 oz. speedmixer cup was charged with 30.28 g of 15-32-1 polymer and 0.29 g absolute ethanol. This mixture was speedmixed at 2300 RPM in 30 second intervals until the alcohol was consumed by the reaction. The resulting polymer demonstrated the EXP-15-32-1 polymer had changed to a Mn of 43511 g/mol, Mw of 80600 g/mol, and D of 1.85. Speedmixer samples were mixed using a Flactec DAC 1200-300 Speedmixer at 2300 rpm in 30 second intervals using 8oz containers.

### EXP-15-40-1, 15-32-1 Gum W/1000 ppm Ethanol

An 8 oz. speedmixer cup was charged with 30.91 g of 15-32-1 polymer and 0.03 g absolute ethanol. This mixture was speedmixed at 2300 RPM in 30 second intervals until the alcohol was consumed by the reaction. The resulting polymer demonstrated the EXP-15-32-1 polymer had changed to a Mn of 95932 g/mol, Mw of 166252 g/mol, and D of 1.73. Speedmixer samples were mixed using a Flactec DAC 1200-300 Speedmixer at 2300 rpm in 30 second intervals using 8oz containers.

### EXP-15-44-1, 15-32-1 Gum W/500 ppm Ethanol

An 8 oz. speedmixer cup was charged with 16.64 g of 15-32-1 polymer and 10.5 μL, absolute ethanol. This mixture was speedmixed at 2300 RPM in 30 second intervals until the alcohol was consumed by the reaction. The resulting polymer demonstrated the EXP-15-32-1 polymer had changed to a Mn of 260856 g/mol, Mw of 487426 g/mol, and D of 1.87.

### EXP-15-36-9, 15-32-1 Gum W/4% 1-Butanol

An 8 oz. speedmixer cup was charged with 26.72 g of 15-32-1 polymer and 1.12 g 1-butanol. This mixture was speedmixed at 2300 RPM in 30 second intervals until the alcohol was consumed by the reaction. The resulting polymer demonstrated the EXP-15-32-1 polymer had changed to a Mn of 15745 g/mol, Mw of 27998 g/mol, and D of 1.78.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula 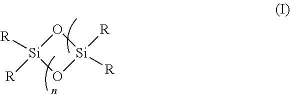
wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide; and
obtaining a product from the mixture, wherein the product comprises formula (II) [(HO)R₂SiO_{1/2}]₂(R₂SiO_{2/2})ₘ, where m>n.

2. The method according to claim 1, wherein n is from 2 to 10.

3. The method according to claim 1, wherein the product has a viscosity of from 2,000 cP to about 200 million cP.

4. The method according to claim 1, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

5. The method according to claim 4, wherein the Lewis acid catalyst is bismuth (III) triflate.

6. The method according to claim 1, wherein the Lewis acid catalyst is present in an amount of 10 ppm to 5000 ppm based on the weight of the cyclic siloxane.

7. The method according to claim 1, wherein the reaction temperature is from about 20° C. to about 120° C.

8. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula 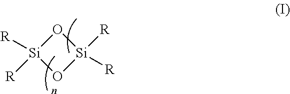
wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with a nucleophilic agent, Z; and
obtaining a product from the mixture, wherein the product comprises formula (III) [(HO)R₂SiO_{1/2}](R₂SiO_{2/2})ₘ[SiO_{1/2}R₂(Z)], wherein m>n and Z comprises an amine, an alkoxy group, a trialkylsiloxy group, an acetate, an alkyl ester, a silazanyl group, an aminosilyl group, or an amino silicone group.

9. The method according to claim 8, wherein n is from 2 to 10.

10. The method according to claim 8, wherein the product has a viscosity of from 2,000 cP to about 200 million cP.

11. The method according to claim 8, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

12. The method according to claim 11, wherein the Lewis acid catalyst is bismuth (III) triflate.

13. The method according to claim 8, wherein the Lewis acid catalyst is present in an amount of 10 ppm to 5000 ppm based on the weight of the cyclic siloxane.

14. The method according to claim 8, wherein the reaction temperature is from about 20° C. to about 120° C.

15. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula 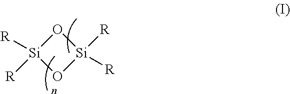
wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with an electrophilic agent, T; and
obtaining a product from the mixture, wherein the product comprises formula (IV) [(TO)R₂SiO_{1/2}](R₂SiO_{2/2})ₘ[SiO_{1/2}R₂(OH)], wherein m>n and T comprises an electrophile.

16. The method according to claim 15, wherein n is from 2 to 10.

17. The method according to claim 15, wherein the product has a viscosity of from 2,000 cP to about 200 million cP.

18. The method according to claim 15, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

19. The method according to claim 18, wherein the Lewis acid catalyst is bismuth (III) triflate.

20. The method according to claim 15, wherein the Lewis acid catalyst is present in an amount of 10 ppm to 5000 ppm based on the weight of the cyclic siloxane.

21. The method according to claim 15, wherein the reaction temperature is from about 20° C. to about 120° C.

22. A method for polymerizing one or more cyclic siloxane(s) comprising:
combining one or more cyclic siloxane(s) with a Lewis acid catalyst at a temperature of from about 20° C. to about 400° C. to form a reaction mixture, wherein the cyclic siloxane(s) comprises a formula 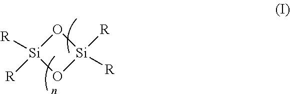
wherein n is from 1 to 20 and each R, independently, is a substituted or unsubstituted C₁ to a C₂₀ alkyl group, a substituted or unsubstituted aryl group, a hydrogen atom, a substituted or unsubstituted alkenyl group, a substituted or unsubstituted amino group, or an alkoxide;
treating the reaction mixture with an electrophilic agent, T and a nucleophilic agent, Z; and
obtaining a product from the mixture, wherein the product comprises formula (V) [(TO)R₂SiO_{1/2]}(R₂SiO_{2/2})ₘ[SiO_{1/2}R₂(Z)],
wherein m>n, Z comprises an amine, an alkoxy group, a trialkylsiloxy group, an acetate, an alkyl ester, a silazanyl group, an aminosilyl group, or an amino silicone group and T comprises an electrophile.

23. The method according to claim 22, wherein n is from 2 to 10.

24. The method according to claim 22, wherein the product has a viscosity of from 2,000 cP to about 200 million cP.

25. The method according to claim 22, wherein the Lewis acid catalyst is bismuth (III) triflate, gallium (III) triflate, indium (III) triflate, iron (III) triflate, scandium (III) triflate, aluminum (III) triflate, dicyclohexylborontrifluoromethanesulfonate, copper (II) triflate, yttrium (III) triflate, cerium (IV) triflate, nonafluorobutane-1-sulfonic acid, trifluoromethanesulfonic acid, phosphononitrilic chloride, zinc (II) triflate, samarium (III) triflate, ytterbium (III) triflate, a boron trihalide, organoboranes and mixtures thereof.

26. The method according to claim 25, wherein the Lewis acid catalyst is bismuth (III) triflate.

27. The method according to claim 25, wherein the Lewis acid catalyst is present in an amount of 10 ppm to 5000 ppm based on the weight of the cyclic siloxane.

28. The method according to claim 28, wherein the reaction temperature is from about 20° C. to about 120° C.
